(19) United States
(12) Patent Application Publication
(10) Pub. No.: US 2006/0248475 A1
(43) Pub. Date: Nov. 2, 2006

(54) Graphical user interface system

(76) Inventor: Thomas Abrahamsson, Linkoping (SE)

Correspondence Address: VENABLE LLP, P.O. BOX 34385, WASHINGTON, DC, 20045-9998, US

(21) Appl. No.: 10/527,057

(22) PCT Filed: Aug. 29, 2003
(86) PCT No.: PCT/SE03/01341

§ 371 Date: Nov. 18, 2005

(30) Foreign Application Priority Data
Sep. 9, 2002 (SE) 0202664-9

(51) Int. Cl. G09G 5/08

(52) U.S. Cl. 715/835; 715/784; 345/157; 715/856

(57) ABSTRACT

A graphical user interface for navigating among and selecting from selectable options presented on a display screen. A scrollable menu including a series of panels representing bookmarks and/or bookmark folders representative of the selectable options is displayed in an approximate semi-circular fashion along the bottom and the sides of the display screen. A cursor is displayed overlaid one panel at the bottom of the display screen. The cursor is scrollable through the series of panels through user input. Upon the cursor being scrolled to a panel appearing further up either side of the display screen than the panels at the bottom thereof the indicated panel is pulled down and stopped at the bottom of the display screen and the whole series of panels scrolled along with it. The user interface further provides for selection of the panel indicated by the cursor through user input.

### TECHNICAL FIELD

The present patent application relates to a system that provides a user interface for efficiently navigating among and selecting from different selectable options presented on a display screen in a simple, intuitive manner in accordance with the preamble of claim 1.

### BACKGROUND OF THE INVENTION

The combination of computer technology with television (TV) and audiovisual (A/V) systems has fostered the development of interactive multimedia entertainment systems. It is known that users desire interactive television and multimedia applications for home, office and mobile use.

One of the most significant challenges in providing interactive television service capability, is the design of an interface which is easy and fun to use by average consumers. Historically, interactive television systems which have been proposed provide a downloaded television listing of programs, video on demand movies, and other options for the user to choose from and execute. The subscriber, utilizing a remote control device in conjunction with a set-top-box coupled to a cable television, satellite direct broadcast, terrestrial broadcast or other communication system, selects a desired movie, program, service or information to be viewed.

In the computer industry, a variety of graphic user interfaces have been developed to facilitate human interaction with computer systems. Many display systems utilize metaphors in the design of the interface as a way to maximize human familiarity, and convey information between the user and computer. It is well known that designing around a familiar metaphor helps reduce human learning time. Most popular graphical user interfaces that are available, such as the Xerox Star™, Apple Macintosh™, and Microsoft Windows™ graphical user interfaces. are based upon the “desk top metaphor”. In a desk top metaphor system, the display screen is treated as a virtual desktop. Graphical symbols placed on the virtual desktop are used to represent common objects found in an office environment, such as files, file folders, and printers. Research in interface design using metaphors and man-machine interfaces, may be applied to multimedia systems, and in particular, to interactive television and audiovisual systems. The marriage of audiovisual and television technology with interactive computer interface technology provides users with maximum flexibility in storing, retrieving, organizing and selecting and/or interacting with content and services.

One such user interface, where user selection is performed through combining two object fields provided within two intersecting bars, which object fields overlap and combine each other when scrolled to a focus area at the cross point of the bars, whereby the object fields in the focus area at the cross point select a feature connected with the combination of fields, which then can be chosen by a confirmation action is previously known through WO 00 65429.

### SUMMARY OF THE INVENTION

One object of the invention is to provide an improved system that provides a graphical user interface for efficiently navigating among and selecting from different selectable options presented on a display screen in a simple, intuitive manner.

This object is achieved in accordance with the characterizing portion of claim 1.

Preferred embodiments are listed in the dependent claims.

### DESCRIPTION OF DRAWINGS

In the following, the invention will be described in greater detail with reference to attached drawings, in which

FIG. 1 is a schematic illustration of a preferred embodiment of a graphical user interface panel menu system in accordance with the present invention,

FIG. 2 is a schematic illustration of the principle for scrolling the panel menu in accordance with FIG. 1,

FIG. 3 is a schematic illustration of the menu in accordance with FIG. 1 when a panel representing an additional subset of user selectable options have been highlighted,

FIG. 4 is a schematic illustration of a subordinate-level menu for the graphical user interface in accordance with the present invention when a user selection of the highlighted panel of FIG. 3 has been made,

FIG. 5 is a schematic illustration of a flow chart Illustrating the menu for a graphical user interface in accordance with the present invention according to FIG. 1.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF EMBODIMENTS

In the following a preferred embodiment will be described with reference to a graphical user interface presented on a display screen 1, e.g. being a television screen associated with an internet enabled set-top-box having a remote control unit providing a man-machine interface for the user to interact with the graphical user interface. However, the present patent application is not limited to the described embodiment in that it is envisaged that the display screen 1 can be any commonly used type of display screen associated with any arbitrary type of multimedia device and man-machine interface.

In the presently preferred embodiment, the user interface is operated using a remote control device which includes up, down, left and right arrow keys to permit the user to move about the graphical user interface. The remote control device also includes an enter or selection key and a key for invoking and/or possibly also for hiding the graphical user interface. Although the present invention is described with reference to a remote control device for the selection of objects and navigation through the present invention's user interface, it will be appreciated by one skilled in the art that a variety of other selection methods and devices may be utilized to accomplish the same result. For example, it is contemplated that the remote control may utilize a joystick instead of the arrow keys for navigation and selection.

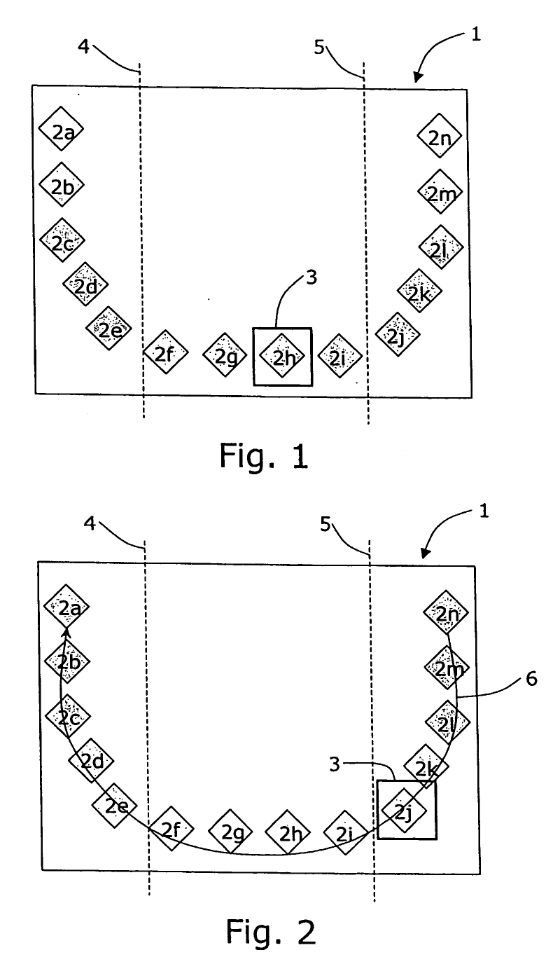

As shown in FIG. 1, bookmarks or folders of bookmarks representative of content and/or interactive services, such as television stations and internet web pages or other functions provided by the multimedia device can be presented as distinct panels 2a-2n, on a single menu 2. The menu overlies the screen 1 and allows the video or television programming to continue playing in the background, such as in the part of the display screen 1 which is not occupied by the menu 2. This also applies to where the background is a web page or any other type of dynamic multimedia visualization so that animation and streaming video can continue to be updated. The user can select the next content-source and/or service, whether internet or television or otherwise based, to be accessed using a cursor 3, e.g. a highlighting selection box, displayed overlaid a panel of the menu 2 and depressing the enter or selection key of the remote control device when the desired panel is indicated. In an alternative embodiment an automated selection of the panel indicated could occur, e.g. when the cursor 3 has been stationary at a certain panel for a predetermined time period. In a further alternative embodiment additional meta data information could be presented, e.g. in a separate picture-in-picture (PIP) window on the display screen 1, upon the cursor 3 being moved to a new panel.

The menu 2 is presented as a series of panels 2a-2n which appear to occupy a two dimensional space extending in an approximately semi-circular fashion across the sides and bottom the display screen 2. The panels 2a-2n on the menu 2 are arranged to be presented on the display screen 2 upon the user depressing the key of the remote control device assigned the function of invoking the menu 2. The menu 2 can include any number of panels, and displays an appropriate number of panels, which can remain legible on the display screen 2.

Each panel 2a-2n is displayed according to its position on the menu 2. For example, an initial position of the menu 2 when accessed by the user for the first time, could be such that a certain part of the panels 2f-2i of the menu 2 have default positions at the bottom of the display screen, thus being the most easily accessible panels. The highlighted selection box 3 could have a default location over either of the panels 2f-2i at the bottom of the display screen 1, i.e. the central area of the screen 1 as delimited by the vertical broken lines 4 and 5.

Although only a small fraction of the available number of panels may be visible in the interface at any one time, the menu 2 displayed, as illustrated by the arrow 6 of FIG. 2, can still simulate movement within a two-dimensional space through being scrolled in a semi-circular fashion, as will be described in more detail below. Any remaining panels will not be displayed when scrolled out of view outside of the display screen 1.

The present invention permits a user to scroll the series of panels 2a-2n in two directions, and thereby navigate through the panels of the user interface. In one embodiment of the present invention, scrolling is accomplished within the user interface by pressing down the arrow key of the remote control device corresponding to the direction in which the user wishes to move the cursor highlighting selection box 3. A central processing unit (CPU) associated with the display device senses the user's selection and responds to the user's button depressing by generating an animation of moving the highlighting selection box 3 of the user interface to the next panel in the series of panels 2a-2n presented on the screen 1 in the direction indicated, thereby bringing the next panel into focus.

The user can utilize the remote control device to select and scan between the panels 2a-2n representing the content and/or services, e.g. television broadcast and internet content, through depressing the “left arrow” and “right arrow” keys of the remote control device to move back and forth between panels, having first accessed the menu 2. Assume for the sake of example that a user desires to move to the right in the queue of panels. The user operates the remote control device using the right arrow key, thereby moving the highlighting selection box 3 to the right in the series of panels 2a-2n displayed on the screen 1. The highlighting selection box 3 preferably jumps between panels in discrete steps, distinctly indicating only one panel at any time.

The panels 2a-2n can include text and/or graphics to describe and symbolize content and/or services e.g. channels for particular television stations, internet web pages, and other functions provided by the associated multimedia system. Panels are selected by scrolling the menu 2 in order to move the highlighting selection box 3 to the desired panel. Upon the highlighting selection box 3 being brought to a panel, an additional information field can optionally be presented to the display screen 1, providing additional information regarding the selectable option of the panel indicated by the selection cursor 3. The highlighting selection box 3 can be brought to move among the panels 2a-2n as described above e.g. by manipulating the remote control device, such as by depressing the “left arrow” or “right arrow” key on the remote control device. The enter or selection button on the remote control device can be used to select the desired panel highlighted in the selection box 3. The user can also view the panels of the menu adjacent to the panel highlighted in the selection box 3 which fit onto the display screen.

The menu 2 resembles a side view of the lower half of a freewheeling Ferris wheel in certain respects in that the panels at one side of the screen are pulled towards the bottom of the display screen 1 when the user attempt to move the highlighting selection box 3 to a panel 2j placed at a location further up along that side of the display screen 1, i.e. a panel displayed in either of the side areas of the screen as delimited by the broken vertical lines 4 and 5. The panels at the right hand side of the display screen 1 are pulled down towards the bottom of the display screen 1, i.e. the central area as delimited by the broken vertical lines 4 and 5, using a simulated gravitational pull as the load of the highlighting selection box 3 is brought to a panel 2j, and the panel highlighted 2j is brought to a stop at the bottom of the display screen 1 using a simulated frictional force as illustrated in FIG. 4 while the panels at the left hand side of the screen 1 are translated upwards along the left hand side of the screen 1. The transport speed of the panels will increase if the user repeatedly tries to move further up the menu panels located at either side of the display screen 1, e.g. trough rapidly depressing either of the associated arrow keys on the remote control device. This allows the user to more rapidly access panels placed further away from an initial position of the highlighting selection box 3 in the menu 2. Alternatively, the increase in the transport speed of the panels can be obtained by linearly adding to the simulated gravitational pull the further up along the panels at the side of the display screen 1 the user attempts to move the highlighting selection box 3, e.g. with reference to FIG. 1, if the highlighting selection box 3 is brought to either of the panels 2b or 2m, the simulated gravitational pull will be significantly higher than if the highlighting selection box 3 was brought to either of the panels 2e or 2j, closer to the bottom of the display screen 1. Still referring to FIG. 1, the simulated gravitational pull above panels 2b and 2m could be designed to be of such magnitude that the transport speed of the panels and the highlighting selection box being scrolled therewith surpasses the speed of which the user can countermove the highlighting selection box 3, i.e. the highlighting selection box 3 can at the most be moved to either of panels 2a or 2n. The simulated frictional force is designed to bring the panel indicated and the highlighting selection box scrolled with it to a stop at the bottom central part of the display screen 1 within the broken vertical lines 4 and 5, independent of the original transport speed of the panels.

The user can edit the content and/or services represented by the panels 2a-2n of the menu 2. The user can bookmark particular web pages and/or services to appear as new panels in the menu 2. Other panels may be added to the menu 2 for cable television channels, satellite channels, and other information sources or functionalities of the associated multimedia device. It is also envisaged that the user might be able to perform additional editing functions, such as e.g. sorting and moving panels. In order for the user to invoke an editing mode, the remote control device might be provided with an optional “edit” key. Also, different menus can be made available so that several different users can operate the system using different menus with a personalized selection of panels.

The panels 2a-2n can be organized either as a circular queue or a simple line queue having two distinct ends and any suitable data structure can be used to keep track of the panels in the queue. The queue is initially preloaded with panels, and any arbitrary panel can be set to correspond to the panel which is to be highlighted in the selection box 3. Thereafter, the last visited panel can be stored so that when the user returns to the menu 2, the menu and panel for the last viewed channel is displayed and highlighted. Several panels of the menu adjacent to the highlighted panel are displayed on the screen. The panel order is preferably maintained during scrolling of the queue, even when scrolled out of view.

In the presently preferred embodiment, when a user selects a panel, the central processing unit (CPU) associated with the display device senses the user's selection and generates an animation which displays the menu 2 disappearing down below the bottom of the display screen 1 whereupon the desired content and/or service is displayed un-obscured by the menu 2 to the full display screen 1.

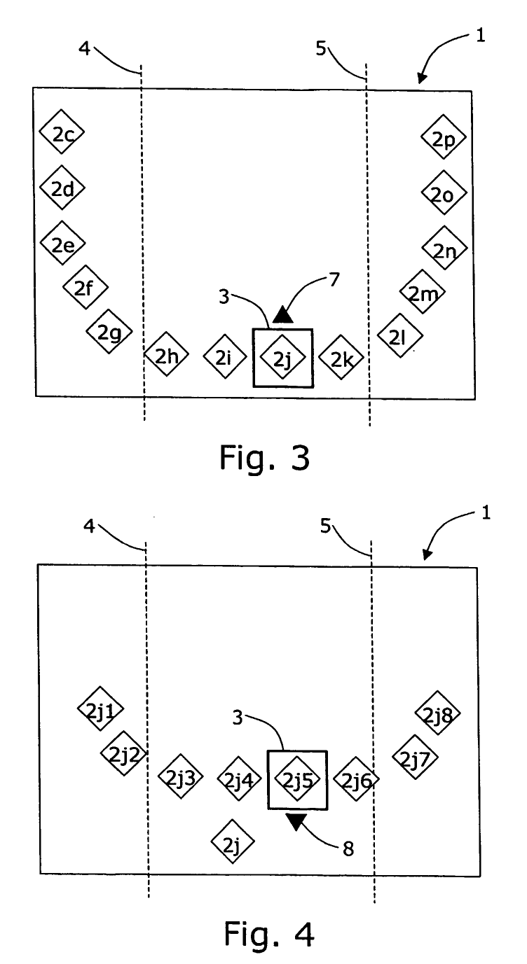

As shown in FIG. 3 the panel 2j highlighted through the selection illustrated in FIG. 2 has been scrolled to a stop in the bottom area of the screen 1, this scrolling at the same time causing panels 2a and 2b to be scrolled of the screen, and previously not displayed panels 2o and 2p to be scrolled onto the screen. If the panel 2j highlighted through the selection illustrated in FIG. 2 represents a folder or container comprising a further subset of selectable panels, this can be indicated e.g. by presenting a first information symbol, e.g. an arrow symbol 7 pointing upwards from the selection box 3, indicating to the user that a sub-menu comprising the series of additional panels can be displayed through depressing an up-arrow key on the remote control device. If the user selects such a highlighted up-arrow tagged folder 2j through depressing the up-arrow key or possibly the enter or selection key the previous menu 2 will be brought to move of the screen 1 in the manner described above. The purpose of the panels moving of the screen 1 is to permit users to obtain more selectable options, without unnecessarily obscuring the background image.

FIG. 4 illustrates how the previous menu of FIG. 3, upon selection of an up-arrow folder 2j, is replaced by a sub-menu presenting the new subset of selectable panels 2j1-2j8 in similar fashion as before. In order to provide the user with an easily understood way of returning to the higher level menu of FIG. 3, the highlighting selection box 3 in this case can be provided with a second information symbol, e.g. a graphical representation of a down arrow 8, indicating to the user that it is possible to return to the higher level menu by depressing a down arrow key of the remote control device. In order to further assist the user in navigating between different level menus a graphical representation of the “up-arrow” tagged panel 2j used to enter the subordinate menu can be displayed below the panels 2j1-2j8 of the sub-menu. In similar fashion the user can then continue to scroll the subset of selectable panels 2j1-2j8 and select either finite panels, containing bookmarks representing finite selections, resulting in the immediate presentation of a desired content and/or service, or additional “up-arrow” tagged panels containing further sub-sets of selectable panels, which will then be displayed in similar fashion to what has been described above.

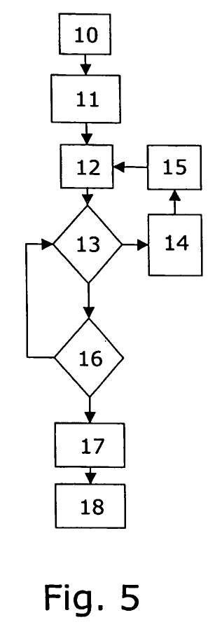

FIG. 5 is a flow chart illustrating a process for implementing the graphical user interface in accordance with the presently preferred embodiment. The user first activates the menu e.g. by depressing the key for invoking the menu, e.g. a menu button on the remote control device (step 10), and the client determines the position of the panels on the simulated menu relative to the screen (step 11). The panels which would be visible at the bottom and sides of the display screen are displayed on the display screen (step 12).

If the user selects a command to scroll the menu, e.g. by depressing either of the left-arrow or right-arrow keys (step 13), the relative panel positions are updated (step 14), and the queue of panels are moved horizontally along the bottom of the screen and vertically along the sides of the screen to animate in an apparently smoothly sliding fashion the simulated movement of the menu displayed on the display screen (step 15). A pointer can be used to track the position of a panel in the queue for the menu. The pointer is updated, either by incrementing or decrementing the pointer in accordance with the user's commands. The movement of the menu is then animated in accordance with the user's commands. As the animation of the menu is completed, the panels are displayed in the new position (step 12) according to the pointer location in order to smoothly animate the movement of the panels.

If the user has entered a command to select the content and/or service represented by the highlighted panel (step 16), the pointer value is saved, the menu is no longer displayed (step 17), and the content and/or service represented by the selected panel is displayed on the display screen (step 18). Another routine (not shown in the flow chart) can be launched where the selection of the panel requires additional processing, whether web browsing or television signal decoding. For example, where a user selects a panel used to bookmark a television program guide page, the menu routine is exited and the routine for presenting the program guide is executed.

Further, if the user has entered a command to select a panel which represents a folder or container comprising a further subset of selectable panels, as described with reference to FIGS. 3 and 4, the higher level menu will be replaced with the sub-ordinate level menu whereupon the flow chart of FIG. 5 is repeated from the top, repeating the steps described above until such a panel is selected by the user which represent a finite bookmark, whereupon the menu is hidden.

It is anticipated that a regular user of the present invention may desire to select content and/or services without triggering the user interface, thereby saving time. Thus, in accordance with the presently preferred embodiment of the invention, it will be possible to “zap” through the finite bookmark representations of content and/or services represented by the queue of panels of the highest level menu in conventional manner, e.g. using the up and down arrows of a remote control device. In an alternative embodiment the “zapping” functionality might be applied to all panels of all level menus provided by the user interface. In yet a further embodiment it is envisaged that certain keys of the remote control device, e.g. the numerical keys of the remote control device, are associated with certain pre-selected or user defined panels, thus providing shortcuts to the selectable options provided by the associated panels.

The present invention as described provides methods and apparatus for a unique graphical user interface for multimedia applications suitable for devices such as interactive television appliances (e.g. set-top-boxes), web-pads, personal digital assistants, mobile phone handsets, and other devices for suitable for presenting audiovisual programs and services to a user thereof. The present invention's functions and features provide a user interface which assists users to find and view content and/or services of interest, access related information, control a variety of audiovisual functions and devices from their homes and offices or while being mobile.

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A graphical user interface system for efficiently navigating among and selecting from different selectable options presented on a display screen, said display screen being associated with a client device and means for user input, wherein
a scrollable menu is provided for selectively through user input being presented to the display screen, which scrollable menu comprises a series of panels representing bookmarks and/or bookmark folders representative of the different selectable options, which series of panels when presented to the display screen will appear to occupy a two-dimensional space extending in an approximate semi-circular fashion along the bottom and the adjacent sides of the display screen such that additional information can be presented for viewing on the remainder of the display screen;
a selection cursor is provided for being presented to the display screen overlaid one panel presented at the bottom of the display screen, which selection cursor through user input is selectively scrollable through the series of panels and, which selection cursor upon being scrolled to a panel appearing further up either side of the display screen than the panels displayed at the bottom thereof is arranged to cause the indicated panel to be pulled down and stopped in a position at the bottom of the display screen and the whole series of panels to be scrolled along with it, said user interface system further providing for user input for performing a selection of the panel indicated by said selection cursor.

2. The graphical user interface according to claim 1, wherein an information field is provided for being presented to the display screen, providing additional information regarding the selectable option of the panel indicated by said selection cursor.

3. The graphical user interface according to claim 1, wherein the transport speed of the series of panels when scrolled is arranged to be increased linearly the further up the panels appearing at either side of the display screen the user attempts to scroll the selection cursor.

4. A The graphical user interface according to claim 1, wherein the transport speed of the series of panels when scrolled is arranged to be dependent on the frequency of user input commands for scrolling the selection cursor up the panels appearing at either side of the display screen.

5. The graphical user interface according to claim 1, wherein it further provides for user input for editing the bookmarks and/or bookmark folders representative of the different selectable options.

6. The graphical user interface according to claim 1, wherein a first information symbol is provided for being displayed to the display screen adjacent to the selection cursor when the panel indicated by said selection cursor is a panel representing a bookmark folder, said first information symbol indicating a path to a sub-menu comprising a series of additional panels representing the bookmarks and/or bookmark folders represented by the panel indicated.

7. The graphical user interface according to claim 6, wherein upon user input for performing a selection of the panel representing a bookmark folder, the sub-menu comprising a series of additional panels representing the bookmarks and/or bookmark folders represented by the panel selected are provided for being displayed to the display screen, replacing the previously displayed menu.

8. The graphical user interface according to claim 7, wherein a second information symbol is provided for being displayed to the display screen adjacent to the selection cursor when the panel indicated by said selection cursor is a panel of said sub-menu, said second information symbol indicating a return path to the previous menu.

9. The graphical user interface according to claim 8, wherein the panel representing the bookmark folder is provided for being displayed to the display screen below the panels of said sub-menu, indicating to the user the panel used to enter said sub-menu.
